(19) United States
(12) Patent Application Publication
(10) Pub. No.: US 2019/0170210 A1
(43) Pub. Date: Jun. 6, 2019

(54) VEHICLE SKELETON SUPPORT APPARATUS

(71) Applicant: SUMITOMO RIKO COMPANY LIMITED, Komaki-shi (JP)

(72) Inventor: Akira OHJI, Komaki-shi (JP)

(73) Assignee: SUMITOMO RIKO COMPANY LIMITED, Komaki-shi (JP)

(21) Appl. No.: 16/269,841

(22) Filed: Feb. 7, 2019

Related U.S. Application Data
(63) Continuation of application No. PCT/JP2017/032048, filed on Sep. 6, 2017.

(30) Foreign Application Priority Data
Jan. 30, 2017 (JP) 2017-014682

(51) Int. Cl. F16F 15/08; F16F 9/32

(52) U.S. Cl. CPC F16F 15/085; B62D 21/15; F16F 9/3207

(57) ABSTRACT

A vehicle skeleton support apparatus configured to be attached and disposed in a vehicle body skeleton including: first and second attachments configured to be attached at separate sections in a rigid member constituting the body skeleton; a high attenuating elastic body elastically connecting an inner shaft-shaped part provided at the first attachment to an outer tubular part provided at the second attachment and disposed externally about the inner shaft-shaped part, in an axis-perpendicular direction; and an intermediate member interposed in a connection part of the elastic body to at least one of the inner shaft-shaped part and the outer tubular part such that the elastic body is connected with it via the intermediate member, wherein an attenuating action by deformation of the elastic body is exhibited against relative displacement between the attachments in any of axial, axis-perpendicular, torsional, and prizing directions.

### INCORPORATED BY REFERENCE

This application is a Continuation of International Application No. PCT/JP2017/032048 filed Sep. 6, 2017, which claims priority under 35 U.S.C. §§ 119(a) and 365 of Japanese Patent Application No. 2017-014682 filed on Jan. 30, 2017, the disclosures of which are expressly incorporated herein by reference in their entireties.

### BACKGROUND OF THE INVENTION

### 1. Field of the Invention

The present invention relates to a vehicle skeleton support apparatus that is attached in a body skeleton of a vehicle so as to reduce a deformation amount of the body skeleton.

### 2. Description of the Related Art

Conventionally, since the body skeleton of the vehicle had high rigidity, the resonance frequency of the body skeleton was a higher frequency than the frequency of a vibration that can be input in practical use of the vehicle. Thus, amplification of the vibration due to the resonance of the body skeleton was less likely to become a problem.

Recently, in order to realize a high demand for weight reduction of vehicles, the body skeleton of the vehicle has become lighter, and the resonance frequency of the body skeleton becomes lower as the rigidity decreases according to weight reduction. As a result, deterioration of the vibration state due to the resonance of the body skeleton or the like has become a problem. In view of this, as one countermeasure for such deterioration of the vibration state, there has been proposed a vehicle skeleton support apparatus for reducing the vibration of the body skeleton by being attached and disposed in the body skeleton of the vehicle.

Specifically, as the vehicle skeleton support apparatus, there are provided in the market an apparatus disclosed in U.S. Pat. No. 9,382,966 and an apparatus using fluid flow resistance.

However, the vehicle skeleton support apparatus of any of these structures has an inherent problem that the structure is complicated and it is difficult to manufacture. Moreover, in the device of U.S. Pat. No. 9,382,966 using frictional damping, the attenuating force works effectively for an input in an axial direction and a torsional direction, but it is less likely to effectively act on an input in a prizing direction. In the apparatus using the flow resistance of the fluid, the attenuating force effectively acts on the input in the axial direction, but it is less likely to effectively act on the input in the torsional direction and the prizing direction.

In the device using the flow resistance of the fluid, the exerted attenuating force largely depends on deformation velocity of the body skeleton. Consequently, there was also a problem that it is difficult to obtain the attenuating force at the initial period of deformation of the body skeleton with a small deformation velocity.

U.S. Pat. No. 6,595,533 discloses a vehicle skeleton support apparatus having a structure wherein a rod-like member is inserted into a longitudinal tubular member and bonded by vulcanization to the tubular member in a gap between them, using an elastic member. According to this, it is possible to exert the attenuating force with respect to the torsional direction and the prizing direction. However, it is difficult in itself to manufacture the apparatus by molding the elastic member directly between such longitudinal members by vulcanization and adhering the longitudinal members. It may be difficult to confirm the fixing state of the elastic member such as whether the elastic member is disposed at a desired portion even after the manufacture. Due to problems like this, there is a possibility that stable vibration damping characteristics cannot be exhibited.

### SUMMARY OF THE INVENTION

The present invention has been developed in view of the above-described matters as the background, and it is an object of the present invention to provide a vehicle skeleton support apparatus with a novel structure which is capable of surely exhibiting desired vibration damping characteristics with a simple structure, applying an effective attenuating force with respect to inputs in many directions, and reducing the velocity dependence of the attenuating force.

The above and/or optional objects of this invention may be attained according to at least one of the following preferred embodiments of the invention. The following preferred embodiments and/or elements employed in each preferred embodiment of the invention may be adopted at any possible optional combinations.

Specifically, the first preferred embodiment of the present invention provides a vehicle skeleton support apparatus configured to be attached and disposed in a vehicle body skeleton comprising: a first attachment and a second attachment configured to be attached respectively at a first attaching section and a second attaching section set at separate positions in a single rigid member constituting the body skeleton; an inner shaft-shaped part provided at the first attachment; an outer tubular part provided at the second attachment, the outer tubular part being externally disposed about the inner shaft-shaped part; a high attenuating elastic body elastically connecting the inner shaft-shaped part and the outer tubular part with each other in an axis-perpendicular direction; and an intermediate member interposed in a connection part of the high attenuating elastic body to at least one of the inner shaft-shaped part and the outer tubular part such that the high attenuating elastic body is connected with the at least one via the intermediate member, wherein an attenuating action by deformation of the high attenuating elastic body is exhibited in relation to relative displacement between the first attachment and the second attachment in any of an axial direction, the axis-perpendicular direction, a torsional direction, and a prizing direction.

According to this vehicle skeleton support apparatus having the structure following the first preferred embodiment, it has a structure wherein the inner shaft-shaped part of the first attachment and the outer tubular part of the second attachment are elastically connected by the high attenuating elastic body. Therefore, the kinetic energy of deformation of the rigid member constituting the body skeleton is reduced by the damping performance of the high attenuating elastic body. As a result, the deformation of the body skeleton of the vehicle is suppressed, so that ride comfort and running performance of the vehicle improve.

Further, since the energy attenuating action is exerted by the elastic deformation of the high attenuating elastic body connecting the first attachment and the second attachment, it is possible to reduce velocity dependence of the attenuating force as compared with the case of using the flow resistance of the fluid or the like. Owing to this, it is possible for example to provide excellent damping performance even at the initial period of deformation where the deformation velocity of the body skeleton is small. Moreover, it is possible to provide a damping action irrespective of the direction of the relative displacement between the first attachment and the second attachment. Therefore, it is possible to provide an effective damping action for various modes of deformation of the body skeleton, and the degree of freedom in setting the attachment position in relation to the rigid member constituting the body skeleton increases.

Furthermore, it is possible to provide damping to the body skeleton by a simple structure wherein the inner shaft-shaped part of the first attachment and the outer tubular part of the second attachment are elastically connected by the high attenuating elastic body. Therefore, it is possible to minimize an increase in weight of the vehicle due to attachment of the vehicle skeleton support apparatus, and to save space in the installation area in the vehicle by a smaller size of the vehicle skeleton support apparatus.

In addition, the connection of the high attenuating elastic body to the at least one of the inner shaft-shaped part and the outer tubular part is realized via the intermediate member interposed between them. Accordingly, there is no need to employ a structure wherein the inner shaft-shaped part and the outer tubular part are elastically connected directly by the high attenuating elastic body. That is, the high attenuating elastic body is first interposed between the intermediate member and one of the inner shaft-shaped part and the outer tubular part so as to elastically connect them. Then, the intermediate member is connected with the other of the inner shaft-shaped part and the outer tubular part. Only by these steps, it is possible to realize an elastic connection structure by the high attenuating elastic body interposed between the first attachment and the second attachment. Therefore, even when the vehicle skeleton support apparatus is elongated, it is possible to easily manufacture the elastic coupling structure between the inner shaft-shaped part and the outer tubular part by the high attenuating elastic body. Further, by adopting the intermediate member, it is possible to more easily and surely confirm the state of the high attenuating elastic body being fixed to the intermediate member, and to the inner shaft-shaped part or the outer tubular part. This makes it possible to improve manufacturing efficiency and reliably and stably realize the desired vibration damping performance.

A second preferred embodiment of the present invention provides the vehicle skeleton support apparatus according to the first preferred embodiment, wherein at least one of the first attachment and the second attachment is constituted by a press metal fitting.

According to the second preferred embodiment, the at least one of the first attachment and the second attachment can be easily and inexpensively manufactured by press working.

A third preferred embodiment of the present invention provides the vehicle skeleton support apparatus according to the first or second preferred embodiment, wherein at least one of the first attachment and the second attachment is constituted by a molded article.

According to the third preferred embodiment, it is possible to manufacture the at least one of the first attachment and the second attachment with a large degree of freedom in shape by molding.

A fourth preferred embodiment of the present invention provides the vehicle skeleton support apparatus according to any one of the first to third preferred embodiments, wherein at least one of the first attachment and the second attachment is constituted by a fiber-reinforced resin or an aluminum alloy.

According to the fourth preferred embodiment, the at least one of the first attachment and the second attachment is made of a fiber-reinforced resin or an aluminum alloy, so that a sufficient rigidity can be ensured and weight reduction can be achieved, compared with items made of iron, or the like.

A fifth preferred embodiment of the present invention provides the vehicle skeleton support apparatus according to any one of the first to fourth preferred embodiments, wherein the high attenuating elastic body is constituted by an isobutylene-isoprene based rubber or a styrene-butadiene based rubber.

According to the fifth preferred embodiment, deformation of the body skeleton can be effectively reduced by forming the high attenuating elastic body with the elastomer having excellent damping performance.

A sixth preferred embodiment of the present invention provides the vehicle skeleton support apparatus according to any one of the first to fifth preferred embodiments, wherein the second attachment has a structure wherein first and second plate-shaped members which are each formed by an elongated press plate metal fitting are superposed on each other, two grooves are formed in the first and second plate-shaped members so as to extend linearly in a longitudinal direction of the first and second plate-shaped members with a semi-circular cross section, and one side end of the grooves is an opened end at an end edge in the longitudinal direction, while an other side end of the grooves is a terminal in a middle part in the longitudinal direction of the first and second plate-shaped members, the grooves in the first and second plate-shaped members are superposed on each other so as to constitute the outer tubular part into which the inner shaft-shaped part is inserted, superposition areas in both side parts in a width direction of the grooves and in an edge part on a side of the terminal in the longitudinal direction in the first and second plate-shaped members are fixed to each other, and the intermediate member comprises an intermediate sleeve fixed on an outer peripheral face of the high attenuating elastic body, and the intermediate sleeve is secured press-fit into the outer tubular part constituted by the grooves of the first and second plate-shaped members so that the outer peripheral face of the high attenuating elastic body is fixed to the outer tubular part.

According to the sixth preferred embodiment, by overlapping the first and second plate-shaped members, the second attachment having the outer tubular part can be formed by the press plate metal fitting, and the second attachment can be easily manufactured.

Furthermore, the intermediate sleeve fixed to the outer peripheral face of the high attenuating elastic body is secured press-fit in the outer tubular part, so that the second attachment having the outer tubular part is fixed to the outer peripheral face of the high attenuating elastic body later. Consequently, it is unnecessary in molding the high attenuating elastic body to set the second attachment in the mold so as to fix the second attachment to the high attenuating elastic body. Therefore, for example, even if the second attachment is relatively large, there is no need to increase the size of the mold for the high attenuating elastic body, and the reduction in mass productivity is prevented.

A seventh preferred embodiment of the present invention provides the vehicle skeleton support apparatus according to the sixth preferred embodiment, further comprising: an attached part configured to be attached to the second attaching section of the rigid member, the attached part being provided in the first and second plate-shaped members, on a side of the other side end located opposite to the opened end of the grooves in the longitudinal direction; and a reinforcer extending from the terminal of the grooves toward the attached part, the reinforcer being constituted by small grooves extending in the longitudinal direction with a cross sectional shape smaller than a cross sectional shape of the grooves being superposed on each other, in the first and second plate-shaped members.

According to the seventh preferred embodiment, the reinforcer is provided between the one side end in the longitudinal direction of the second attachment reinforced by forming the outer tubular part and the other side end in the longitudinal direction of the second attachment attached to the second attaching section of the rigid member. Consequently, the deformation rigidity of the second attachment formed by overlapping the first and second plate-shaped members can be largely obtained. In particular, this reinforcer is provided in a structure of superposed small grooves in a direction in which the outer tubular part extends. This makes it possible to exhibit good reinforcement effect not only in the tensile direction of the second attachment but also in each direction such as bending and torsion.

An eighth preferred embodiment of the present invention provides the vehicle skeleton support apparatus according to the seventh preferred embodiment, wherein the attached part includes a through hole penetrating the first and second plate-shaped members in a superposition direction of the first and second plate-shaped members, the small grooves constituting the reinforcer open in the terminal of the grooves constituting the outer tubular part, and the small grooves are provided with a length such that the small grooves do not reach the through hole in the longitudinal direction of the first and second plate-shaped members.

According to the eighth preferred embodiment, the small grooves constituting the reinforcer are formed continuously with the grooves constituting the outer tubular part. The second attachment is continuously reinforced by the reinforcer and the outer tubular part in the longitudinal direction. Owing to these, the high deformation rigidity can be set for the second attachment.

Furthermore, since the reinforcer is formed to extend to a position that does not reach the through hole, a large degree of freedom in the shape of the second attachment is ensured in the through hole attached to the rigid member and the periphery of the through hole. In addition, in the attached state of the second attachment to the rigid member, the periphery of the through hole is reinforced by attachment to the rigid member. Thus, even if the reinforcer is formed at a position that does not reach the through hole, the deformation rigidity of the second attachment can be largely provided.

A ninth preferred embodiment of the present invention provides the vehicle skeleton support apparatus according to any one of the sixth to eighth preferred embodiments, wherein a passage hole is provided in the outer tubular part which is constituted by the first and second plate-shaped members while extending in the longitudinal direction along an outer peripheral face of the intermediate sleeve, in superposition parts of both circumferential ends of the grooves of the first and second plate-shaped members, and

an internal space on a deeper side in the longitudinal direction in the outer tubular part into which the inner shaft-shaped part and the high attenuating elastic body are inserted communicates with an external space via the passage hole.

According to the ninth preferred embodiment, at the time of press-fitting the intermediate sleeve into the outer tubular part, the internal space on the deeper side in the longitudinal direction of the outer tubular part is prevented from being sealed. This makes it possible to prevent the unnecessary initial load due to air spring from acting on the high attenuating elastic body, and to prevent the press fitting operation from being difficult.

A tenth preferred embodiment of the present invention provides the vehicle skeleton support apparatus according to any one of the first to fifth preferred embodiments, wherein the second attachment includes the outer tubular part having two openings on opposite axial sides, and an attached part assembled to one of the openings of the outer tubular part and configured to be attached to the second attaching section, the intermediate member comprises a tubular first intermediate sleeve with a diameter smaller than a diameter of the outer tubular part, and the first intermediate sleeve is housed and disposed in the outer tubular part, and an outer peripheral face of the high attenuating elastic body is connected with a radially inner face of the outer tubular part, while a radially inner face of the high attenuating elastic body is fixed to an outer peripheral face of the first intermediate sleeve, and the inner shaft-shaped part of the first attachment is inserted in the first intermediate sleeve from a side of an other of the openings of the outer tubular part, and the inner shaft-shaped part is fixed to the first intermediate sleeve by a fastener.

According to the tenth preferred embodiment, the second attachment includes the outer tubular part having openings on both axial sides and an attached part to be assembled to one of the openings of the outer tubular part. The tubular first intermediate sleeve as the intermediate member having a smaller diameter than that of the outer tubular part is housed and disposed inside the outer tubular part. The first intermediate sleeve and the outer tubular part are elastically connected with each other by the high attenuating elastic body interposed between them. Therefore, at the manufacturing stage, it is possible to more easily and reliably take out only the outer tubular part and interpose and adhere the high attenuating elastic body between the outer tubular part and the first intermediate sleeve before assembling the outer tubular part and the attached part. After that, the inner shaft-shaped part is inserted into the first intermediate sleeve and fastened and secured to the first intermediate sleeve by the fastener. This work can be performed readily and efficiently when the openings on both axial sides of the outer tubular part are opened. Then, after completion of operations such as elastic connection of the outer tubular part and the first intermediate sleeve by the high attenuating elastic body, and fastening securement of the inner shaft-shaped part to the first intermediate sleeve, the work of assembling the attached part to one of the openings of the outer tubular part in order to constitute the second attachment is performed. By so doing, the vehicle skeleton support apparatus can be more advantageously and stably manufactured.

The assembly of the attached part to one of the openings of the outer tubular part can be performed by any well-known method such as press fitting, drawing operation, caulking process, welding or the like. Further, as a fastening structure for fastening and fixing the inner shaft-shaped part to the first intermediate sleeve, any well-known fastening structure such as a screw or a rivet can be adopted. Further, the outer peripheral face of the high attenuating elastic body may be fixed and connected directly to the outer tubular part, or it may be indirectly connected via the second intermediate sleeve like a thirteenth preferred embodiment described later.

An eleventh preferred embodiment of the present invention provides the vehicle skeleton support apparatus according to the tenth preferred embodiment, wherein a screw part protrudes in a distal end of the inner shaft-shaped part of the first attachment, and an engager is provided at a middle part of the inner shaft-shaped part so as to engage with an end face of the first intermediate sleeve, and the first intermediate sleeve is clamped between a nut threaded onto the screw part and the engager so that the inner shaft-shaped part of the first attachment is fixed to the first intermediate sleeve, and the fastener includes the screw part, the engager, and the nut.

According to the eleventh preferred embodiment, the fastening structure for fastening and fixing the inner shaft-shaped part to the first intermediate sleeve includes the screw part protruding from the distal end of the inner shaft-shaped part, the engager provided in the middle part, and the nut threaded onto the screw part. Thus, the first intermediate sleeve is clamped between the nut threaded onto the screw part and the engager provided at the middle part of the inner shaft-shaped part, so that the inner shaft-shaped part of the first attachment can be reliably fixed to the first intermediate sleeve. In particular, the inner shaft-shaped part can be disposed across the entire length of the first intermediate sleeve. Therefore, when the vehicle skeleton support apparatus is long, stable fixing of the first intermediate sleeve and the inner shaft-shaped part can be advantageously realized. This structure can be adopted because the fastening operation can be performed in a state in which one opening in the axial direction of the outer tubular part is released.

A twelfth preferred embodiment of the present invention provides the vehicle skeleton support apparatus according to any one of the first to fifth preferred embodiments, wherein the second attachment includes the outer tubular part having two openings on opposite axial sides, and an attached part assembled to one of the openings of the outer tubular part and configured to be attached to the second attaching section, the intermediate member comprises a tubular first intermediate sleeve with a diameter smaller than a diameter of the outer tubular part, and the first intermediate sleeve is housed and disposed in the outer tubular part, and an outer peripheral face of the high attenuating elastic body is connected with a radially inner face of the outer tubular part, while a radially inner face of the high attenuating elastic body is fixed to an outer peripheral face of the first intermediate sleeve, and the inner shaft-shaped part of the first attachment is secured press-fit into the first intermediate sleeve from a side of an other of the openings of the outer tubular part.

According to the twelfth preferred embodiment, the second attachment includes the outer tubular part having the openings on both axial sides and the attached part assembled to the one of the openings of the outer tubular part. The tubular first intermediate sleeve as the intermediate member having a smaller diameter than that of the outer tubular part is housed and disposed inside the outer tubular part. The first intermediate sleeve and the outer tubular part are elastically connected with each other by the high attenuating elastic body interposed between them. Therefore, at the manufacturing stage, it is possible to more easily and reliably take out only the outer tubular part and interpose and adhere the high attenuating elastic body between the outer tubular part and the first intermediate sleeve before assembling the outer tubular part and the attached part. After that, the inner shaft-shaped part is secured press-fit into the first intermediate sleeve. This press-fit work can be also securely realized when the openings on both axial sides of the outer tubular part are in a released state, because holding of the first intermediate sleeve in press-fitting can be performed from a side of one of the openings of the outer tubular part. Then, after completion of operations such as elastic connection of the outer tubular part and the first intermediate sleeve by the high attenuating elastic body, and press-fit securement of the inner shaft-shaped part to the first intermediate sleeve, the work of assembling the attached part to one of the openings of the outer tubular part in order to constitute the second attachment is performed. By so doing, the vehicle skeleton support apparatus can be more advantageously and stably manufactured.

A thirteenth preferred embodiment of the present invention provides the vehicle skeleton support apparatus according to any one of the tenth to twelfth preferred embodiments, wherein the intermediate member further comprises a tubular second intermediate sleeve with a diameter smaller than the diameter of the outer tubular part and larger than the diameter of the first intermediate sleeve, and the second intermediate sleeve is housed and disposed in the outer tubular part, and the outer peripheral face of the high attenuating elastic body is fixed to a radially inner face of the second intermediate sleeve, while the radially inner face of the high attenuating elastic body is fixed to the outer peripheral face of the first intermediate sleeve, and the second intermediate sleeve is secured press-fit into the outer tubular part so that the outer peripheral face of the high attenuating elastic body is connected with the outer tubular part.

According to a thirteenth preferred embodiment, the high attenuating elastic body is an integrally molded component wherein both the radially inner face and the outer peripheral face of the high attenuating elastic body are fixed to the first intermediate sleeve and the second intermediate sleeve. Consequently, the integrally molded component is connected and fixed to the inner shaft-shaped part and the outer tubular part. This makes it possible to easily manufacture the elastic coupling structure by the high attenuating elastic body interposed between the inner shaft-shaped part and the outer tubular part. Particularly, irrespective of the shapes of the inner shaft-shaped part and the outer tubular part, the integrally molded component incorporating the high attenuating elastic body and the first and second intermediate sleeves can be stably and easily manufactured, so that production efficiency can further improve and performance stability can be kept.

A fourteenth preferred embodiment of the present invention provides the vehicle skeleton support apparatus according to any one of the first to fifth preferred embodiments, wherein the outer tubular part provided at the second attachment has a bottomed cup shape with a base wall provided at one axial end, the intermediate member in a bottomed cup shape with a diameter smaller than a diameter of the outer tubular part is housed and disposed in the outer tubular part, and the high attenuating elastic body is filled in a gap between a face of the base wall of the outer tubular part and a face of a bottom wall of the intermediate member that face each other and a gap between a radially inner face of the outer tubular part and a face of the intermediate member that face each other so that the high attenuating elastic body elastically connects the outer tubular part and the intermediate member in the gaps, and the inner shaft-shaped part of the first attachment is secured press-fit into the intermediate member from an axial opening of the intermediate member toward the bottom wall.

According to the fourteenth preferred embodiment, the intermediate member having a diameter smaller than that of the outer tubular part and having a bottomed cup shape is housed and disposed in the outer tubular part having a bottomed cup shape. The peripheral walls and the base wall and the bottom wall arranged opposite to each other and elastically connected by the high attenuating elastic body filled in the gap between them. As a result, with respect to relative displacement between the first attachment and the second attachment in any of the axial direction, the axis-perpendicular direction, the torsional direction and the prizing direction, there is exhibited the damping action owing to the deformation of the high attenuating elastic body. In addition, to the relative displacement in the axial direction between the first attachment and the second attachment, the compression and tension springs are exerted. As a result, it is possible to facilitate the manufacture and add further vibration damping characteristics.

According to the present invention, by providing damping to the body skeleton of the vehicle, it is possible to reduce the deformation of the body skeleton and improve the ride comfort and running performance of the vehicle. Moreover, by a simple structure wherein the inner shaft-shaped part of the first attachment and the outer tubular part of the second attachment are elastically connected by the high attenuating elastic body, effective attenuation can be exhibited for all of the inputs in many directions. This makes it possible to minimize the weight increase of the vehicle and the size of the required installation space, while largely keeping the degree of freedom of the attachment position in the body skeleton of the vehicle. In addition, by adopting the intermediate member, it is unnecessary to adopt a structure wherein the inner shaft-shaped part and the outer tubular part are elastically connected directly by the high attenuating elastic body. Owing to this, it is possible to reliably and stably realize improvement in manufacturing efficiency and the desired vibration damping performance.

### BRIEF DESCRIPTION OF THE DRAWINGS

The foregoing and/or other objects, features and advantages of the invention will become more apparent from the following description of practical embodiments with reference to the accompanying drawings in which like reference numerals designate like elements and wherein:

FIG. 1 is a front view showing a vehicle skeleton support apparatus as a first practical embodiment of the present invention;

FIG. 2 is a cross-sectional view taken along line 2-2 of FIG. 1;

FIG. 3 is a cross-sectional view taken along line 3-3 of FIG. 1;

FIG. 4 is a view schematically showing an example of an attached state of the vehicle skeleton support apparatus shown in FIG. 1 to a vehicle;

FIG. 5 is a graph showing a simulation result of attenuation characteristics with respect to an axial input of the vehicle skeleton support apparatus;

FIG. 6 is a perspective view showing a vehicle skeleton support apparatus as a second practical embodiment of the present invention;

FIG. 7 is a cross-sectional view taken along line 7-7 of FIG. 6;

FIG. 8 is a perspective view showing a vehicle skeleton support apparatus as a third practical embodiment of the present invention;

FIG. 9 is a cross-sectional view taken along line 9-9 of FIG. 8;

FIG. 10 is a cross-sectional view showing a vehicle skeleton support apparatus as another preferred embodiment of the third practical embodiment of the present invention, corresponding to FIG. 9;

FIG. 11 is a perspective view showing a vehicle skeleton support apparatus as a fourth practical embodiment of the present invention;

FIG. 12 is a cross-sectional view taken along line 12-12 of FIG. 11; and

FIG. 13 is a cross-sectional view showing a vehicle skeleton support apparatus as another preferred embodiment of the second practical embodiment of the present invention, corresponding to FIG. 7.

### DETAILED DESCRIPTION OF EMBODIMENTS

Hereinafter, practical embodiments of the present invention will be described with reference to the drawings.

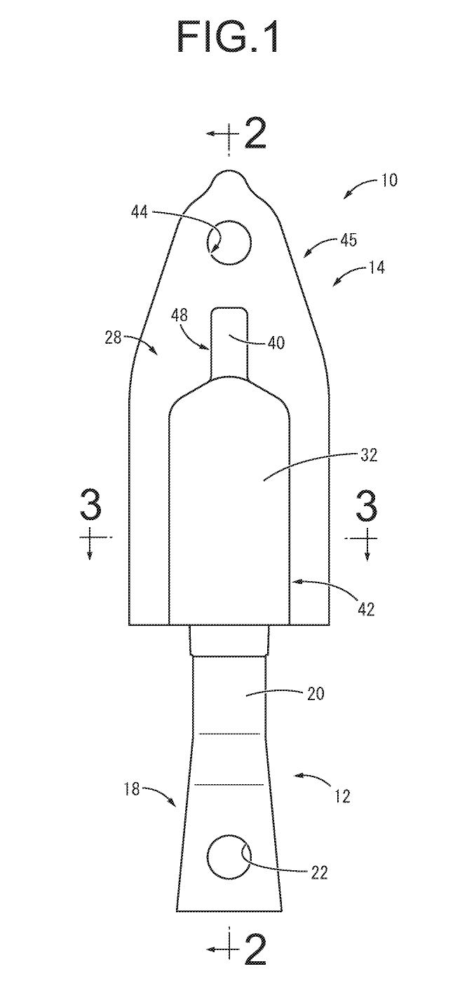

FIGS. 1 to 3 show a vehicle skeleton support apparatus 10 as a first practical embodiment of the present invention. The vehicle skeleton support apparatus 10 has a structure wherein a first attachment 12 and a second attachment 14 are elastically connected to each other by a high attenuating elastic body 16.

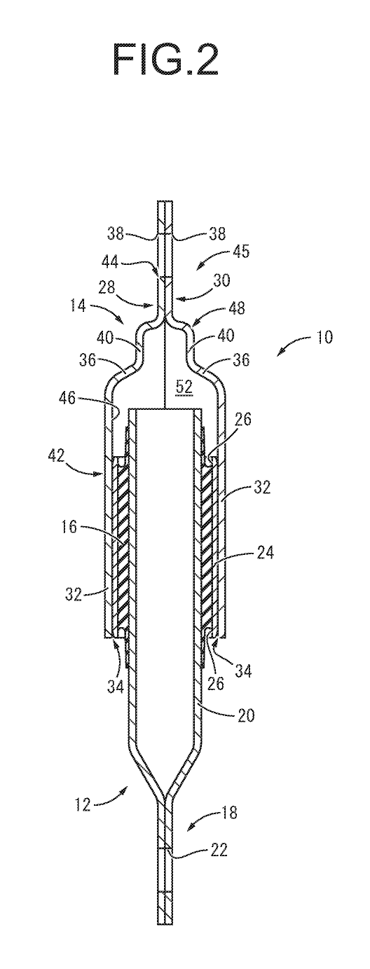

More specifically, the first attachment 12 is a high rigidity member formed of iron, an aluminum alloy, or the like, with a structure wherein one end portion of a substantially cylindrical pipe is crushed flat in a diametrical direction as shown in FIG. 2. For the first attachment 12, the crushed end portion is a plate-shaped attached part 18. Meanwhile, a hollow shaft-shaped part that is separate from the attached part 18, or a substantially cylindrical portion in other words, is an inner shaft-shaped part 20. As will be described later, this attached part 18 is configured to be attached to a first attaching section 60.

The attached part 18 is formed at one end portion in the longitudinal direction (the up-down direction in FIG. 2) of the first attachment 12, and has a circular first bolt hole 22 passing through it in the thickness direction (the left-right direction in FIG. 2).

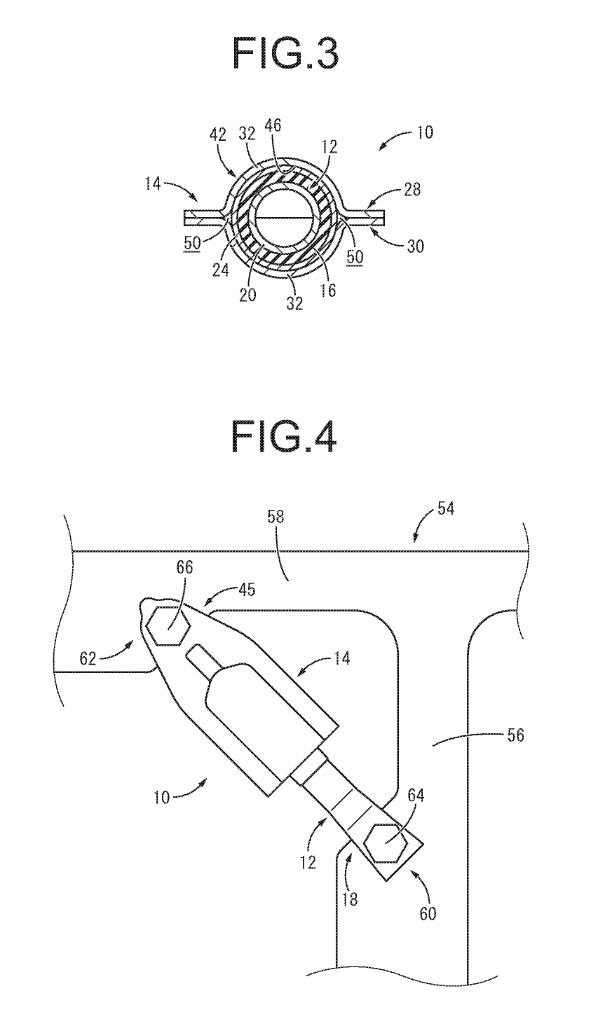

As shown in FIGS. 2 and 3, the inner shaft-shaped part 20 has a substantially cylindrical shape as a whole, and one end in the longitudinal direction connected to the attached part 18 is crushed flat in the diametrical direction and tapered and it is closed at a connecting portion with the attached part 18. The first attachment 12 of the present practical embodiment is formed by crushing one end portion of the pipe obtained by molding such as extrusion processing, in the diametrical direction through press working so as to change it into a plate shape.

An intermediate sleeve 24 is disposed on the outer periphery of the inner shaft-shaped part 20 of the first attachment 12. The intermediate sleeve 24 is formed of a metal such as iron or an aluminum alloy and has a substantially cylindrical shape having a larger diameter and a smaller axial dimension than those of the inner shaft-shaped part 20. The outer peripheral face of each axial end portion of the intermediate sleeve 24 is a tapered face that decreases in diameter as it goes outward in the axial direction.

The inner shaft-shaped part 20 of the first attachment 12 is disposed in the intermediate sleeve 24 such that it is inserted through the intermediate sleeve 24. The high attenuating elastic body 16 is disposed between the inner shaft-shaped part 20 and the intermediate sleeve 24 in the axis-perpendicular direction. The high attenuating elastic body 16 is a substantially cylindrical rubber, resin elastomer or the like, and its radially inner face is fixed to the outer peripheral face of the inner shaft-shaped part 20, while its outer peripheral face is fixed to the radially inner face of the intermediate sleeve 24. As a result, the inner shaft-shaped part 20 and the intermediate sleeve 24 are elastically connected to each other in the axis-perpendicular direction by the high attenuating elastic body 16. The high attenuating elastic body 16 is provided with a groove-like void part 26 which opens in each axial end face and extends annularly in the circumferential direction, so that the free face having a large area is kept at each axial end of the high attenuating elastic body 16.

The material for forming the high attenuating elastic body 16 is selected as appropriate, according to the required capabilities, but a material that exhibits a large energy attenuating action at the time of elastic deformation is desirable. For example, isobutylene-isoprene based rubber including isobutylene-isoprene rubber (IIR), styrene-butadiene based rubber including styrene-butadiene rubber (SBR), urethane rubber and the like can be suitably adopted. In addition, the high attenuating elastic body 16 having excellent damping performance can be obtained also by a styrene-based thermoplastic elastomer. The high attenuating elastic body 16 of the present practical embodiment is formed of a rubber and bonded by vulcanization to the inner shaft-shaped part 20 and the intermediate sleeve 24. The high attenuating elastic body 16 takes the form of an integrally vulcanization molded component incorporating the inner shaft-shaped part 20 and the intermediate sleeve 24.

Further, the intermediate sleeve 24 is fixed to the second attachment 14. In the structure of the second attachment 14, a first plate-shaped member 28 and a second plate-shaped member 30 are superposed in the thickness direction (the left-right direction in FIG. 2) and fixed to each other by means such as welding. In the present practical embodiment, the first plate-shaped member 28 and the second plate-shaped member 30 have a structure of members having the same shape being turned upside down. Thus, the specific structure of the first plate-shaped member 28 will be described below, and, about the second plate-shaped member 30, the description will be omitted by providing the same reference numerals as those of the first plate-shaped member 28 in the drawings.

The first plate-shaped member 28 of the present practical embodiment is a press metal fitting made of metal such as iron or aluminum alloy. As shown in FIGS. 2 and 3, the first plate-shaped member 28 has a groove 32 extending linearly with a semi-circular cross section in the longitudinal direction, on an end side in the longitudinal direction (the lower side in FIG. 2). The groove 32 opens in the lower face of the first plate-shaped member 28 and extends in the longitudinal direction. One side end of the groove 32 is an opened end 34 at one end edge in the longitudinal direction of the first plate-shaped member 28, while the other side end is a terminal 36 in the middle part in the longitudinal direction of the first plate-shaped member 28.

Further, the first plate-shaped member 28 is provided with a through hole 38 on the other end side (the upper side in FIG. 2) in the longitudinal direction relative to the groove 32. The through hole 38 has a circular cross section and penetrates the first plate-shaped member 28 in the thickness direction. Furthermore, the first plate-shaped member 28 is provided with a small groove 40 between the groove 32 and the through hole 38 in the longitudinal direction. The small groove 40 has a smaller cross sectional shape than that of the groove 32 and opens to the lower face and linearly extends from the terminal 36 of the groove 32 to the other end side in the longitudinal direction. The small groove 40 opens in the terminal 36 of the groove 32 to be continuous with the groove 32, and it is formed to have a length such that the small groove 40 does not reach the through hole 38 in the longitudinal direction of the first plate-shaped member 28.

The first plate-shaped member 28 and the second plate-shaped member 30 each having such a structure are superposed in the thickness direction. Superposition areas in the both side parts in the width direction of the grooves 32, 32 and in the edge part on the side of the terminals 36, 36 in the longitudinal direction including the peripheries of the through holes 38 are fixed to each other by welding or the like, thereby constituting the second attachment 14. Further, by superposing the grooves 32, 32 of the first and second plate-shaped members 28, 30 on each other, an outer tubular part 42 having a substantially cylindrical shape is constituted at one end in the longitudinal direction of the second attachment 14. Furthermore, at the other end in the longitudinal direction of the second attachment 14, flat plate portions having the respective through holes 38, 38 are overlapped so as to constitute a plate-shaped attached part 45 having a second bolt hole 44 penetrating it in the thickness direction. The attached part 45 is configured to be attached to a second attaching section 62.

The inner hole of the outer tubular part 42 formed between the groove 32 of the first plate-shaped member 28 and the groove 32 of the second plate-shaped member 30 is a press-fit concave part 46 which opens toward one side in the longitudinal direction of the second attachment 14, at the opened ends 34, 34 of the grooves 32, 32. Furthermore, on the other side in the longitudinal direction of the outer tubular part 42, a reinforcer 48 that protrudes to both sides in the thickness direction at the center portion in the width direction (the left-right direction in FIG. 1) is constituted by the small grooves 40, 40 of the first and second plate-shaped members 28, 30. One end in the longitudinal direction of the inner hole of the reinforcer 48 opens to the wall face of the press-fit concave part 46 on the side of the terminals 36, 36.

The intermediate sleeve 24 as an intermediate member connected elastically to the first attachment 12 by the high attenuating elastic body 16 is secured press-fit into the outer tubular part 42 of the second attachment 14. Consequently, the outer peripheral face of the high attenuating elastic body 16 is fixed to the second attachment 14. As a result, the inner shaft-shaped part 20 of the first attachment 12 and the outer tubular part 42 of the second attachment 14 are elastically connected with each other in the axis-perpendicular direction by the high attenuating elastic body 16. As shown in FIGS. 2 and 3, the other end in the longitudinal direction of the inner shaft-shaped part 20 is inserted in the press-fit concave part 46 formed radially in the outer tubular part 42, substantially coaxially with the press-fit concave part 46, so that the outer tubular part 42 is externally disposed about the inner shaft-shaped part 20.

In the present practical embodiment, the second attachment 14 has a structure wherein the first plate-shaped member 28 and the second plate-shaped member 30, which are press metal fittings, are superposed and fixed to each other. Therefore, the inside dimension of the press-fit concave part 46 is partially enlarged in the circumferential direction at the superposition parts of the circumferential ends of the grooves 32, 32 of the first plate-shaped member 28 and the second plate-shaped member 30. As a result, when the cylindrical intermediate sleeve 24 is press-fitted into the outer tubular part 42 of the second attachment 14, a gap is formed between the radially inner face of the outer tubular part 42 and the outer peripheral face of the intermediate sleeve 24 in the superposition parts of both circumferential ends of the grooves 32, 32 of the first plate-shaped member 28 and the second plate-shaped member 30. Through this gap, a passage hole 50 is formed extending in the longitudinal direction of the second attachment 14 along the outer peripheral face of the intermediate sleeve 24. An internal space 52 located on the deeper side in the press-fit direction than the integrally vulcanization molded component of the high attenuating elastic body 16 communicates with the external space via the passage hole 50.

In this way, the inner shaft-shaped part 20 of the first attachment 12 and the outer tubular part 42 of the second attachment 14 are elastically connected to each other in the axis perpendicular direction by the high attenuating elastic body 16. Owing to this, the high attenuating elastic body 16 undergoes elastic deformation with respect to the relative displacement between the first attachment 12 and the second attachment 14. In particular, even when the first attachment 12 and the second attachment 14 are relatively displaced in any of the axial direction, the axis-perpendicular direction, the torsional direction and the prizing direction, the high attenuating elastic body 16 is elastically deformed. Consequently, an attenuating action based on internal friction or the like of the high attenuating elastic body 16 is exerted.

As shown in FIG. 4, the vehicle skeleton support apparatus 10 structured as described above is attached to a single rigid member constituting a body skeleton 54 of the vehicle. In FIG. 4, a pillar 56 and a roof 58 constituting the body skeleton 54 are integrally formed into the single rigid member, and the first attaching section 60 to which the first attachment 12 of the vehicle skeleton support apparatus 10 is fixed is provided at the pillar 56 and the second attaching section 62 to which the second attachment 14 is fixed is provided at the roof 58.

The first attachment 12 is attached to the first attaching section 60 of the pillar 56 by a first bolt 64 inserted through the first bolt hole 22 of the first attachment 12. Meanwhile, the second attachment 14 is attached to the second attaching section 62 of the roof 58 by a second bolt 66 inserted through the second bolt hole 44 of the second attachment 14. As a result, the vehicle skeleton support apparatus 10 is disposed obliquely so as to straddle the corner of the connecting portion between the pillar 56 and the roof 58, and it is attached and disposed in the body skeleton 54 of the vehicle. Since the first attaching section 60 is provided at the pillar 56 while the second attaching section 62 is provided at the roof 58, the attaching sections 60, 62 are set at mutually separated positions in the rigid member. In the present practical embodiment, the first attaching section 60 and the second attaching section 62 are set at mutually different positions in the front-back direction (the left-right direction in FIG. 4) and the up-down direction (the up-down direction in FIG. 4).

When the body skeleton 54 is deformed by the action of external force in the state where this vehicle skeleton support apparatus 10 is attached to the body skeleton 54, the first attaching section 60 of the pillar 56 and the second attaching section 62 of the roof 58 provided in the body skeleton 54 are relatively displaced. The inner shaft-shaped part 20 of the first attachment 12 fixed to the first attaching section 60 and the outer tubular part 42 of the second attachment 14 fixed to the second attaching section 62 are relatively displaced. This elastically deforms the high attenuating elastic body 16 connecting the inner shaft-shaped part 20 and the outer tubular part 42. This exerts energy damping action owing to internal friction or the like of the high attenuating elastic body 16, thereby reducing the kinetic energy of the body skeleton 54 and thus the deformation amount of the body skeleton 54. As a result, when the vehicle skeleton support apparatus 10 is attached on the vehicle, the adverse effect that the deformation of the body skeleton 54 has on the ride comfort, the running performance such as running stability, and the like of the vehicle is decreased, and the ride comfort, the running performance, and the like can improve.

In particular, the elastic body that elastically connects the first attachment 12 and the second attachment 14 is the high attenuating elastic body 16 made of isobutylene isoprene rubber (IIR), styrene butadiene rubber (SBR) or the like. This makes it possible to advantageously obtain the damping action at the time of elastic deformation and to effectively reduce the deformation of the body skeleton 54. In addition, when the spring constant of the high attenuating elastic body 16 is great, the vibration state may be adversely affected in some cases. However, by selecting the material or the like of the high attenuating elastic body 16 as appropriate, the balance between the spring constant and the damping performance can be adjusted with a great degree of freedom. Therefore, it is possible to obtain the vehicle skeleton support apparatus 10 having the desired capabilities.

Furthermore, since the damping action owing to the elastic deformation of the high attenuating elastic body 16 is utilized, not only when the deformation velocity of the body skeleton 54 is large but also when it is small, a large damping action is effectively exhibited. In short, the dependency of the attenuating force on the difference in deformation velocity of the body skeleton 54 is small in the vehicle skeleton support apparatus 10, and an effective damping action can be stably obtained. Moreover, by utilizing the damping action owing to the elastic deformation of the high attenuating elastic body 16, it is possible to obtain an effective attenuating force even in a region where the deformation velocity of the body skeleton 54 is lower. By selecting the material for forming the high attenuating elastic body 16, etc. as appropriate, it is possible to change not only the magnitude of the attenuating force to be exerted, but also the relationship of the attenuating force with respect to the deformation velocity of the body skeleton 54. Owing to this, the degree of dependency of the damping characteristics on the deformation velocity of the body skeleton 54 can be changed and set as appropriate.

In the vehicle skeleton support apparatus 10, the structure is simple and the damping action is exerted based on the internal friction of the high attenuating elastic body 16. Consequently, variability in the attenuation performance resulting from manufacturing tolerances such as dimensional tolerances of components and assembly tolerances etc. can be suppressed as well.

Not only in the case where the relative displacement direction of the inner shaft-shaped part 20 and the outer tubular part 42 is the axial direction, but also in the case where it is any of the directions such as the axis-perpendicular direction, the torsional direction, and the prizing direction, the high attenuating elastic body 16 undergoes elastic deformation, so that effective damping action of the vehicle skeleton support apparatus 10 is exerted for any cases. Therefore, according to the vehicle skeleton support apparatus 10, irrespective of the deformation mode of the body skeleton 54 or the like, the damping action is exhibited and the deformation amount of the body skeleton 54 can be reduced.

The vehicle skeleton support apparatus 10 has a structure wherein the inner shaft-shaped part 20 of the first attachment 12 and the outer tubular part 42 of the second attachment 14 are elastically connected by the high attenuating elastic body 16. This makes it possible to manufacture the vehicle skeleton support apparatus 10 easily and inexpensively, and it is also easy to achieve miniaturization and weight reduction. In particular, in the present practical embodiment, the intermediate sleeve 24, which is smaller than the outer tubular part 42, is secured press-fit into the outer tubular part 42. Thus, the inner shaft-shaped part 20 and the outer tubular part 42 are elastically connected by the high attenuating elastic body 16. Therefore, as compared with a case where both the inner shaft-shaped part 20 and the outer tubular part 42 are directly bonded by vulcanization to the high attenuating elastic body 16, the integrally vulcanization molded component of the high attenuating elastic body 16 can be made more compact.

Since the second attachment 14 has a structure wherein the first and second plate-shaped members 28, 30 are superposed and fixed to each other, the second attachment 14 including the outer tubular part 42 can be formed by press plate metal fittings, and the second attachment 14 can be easily manufactured.

The intermediate sleeve 24 fixed to the outer peripheral face of the high attenuating elastic body 16 is secured press-fit into the outer tubular part 42, whereby the second attachment 14 including the outer tubular part 42 is fixed to the outer peripheral face of the high attenuating elastic body 16 later. Thus, it is not necessary when molding the high attenuating elastic body 16 to set the second attachment 14 in the mold so as to fix it to the high attenuating elastic body 16. Therefore, for example, even if the second attachment 14 is comparatively large, excellent mass productivity can be realized since it is not necessary to enlarge the mold of the high attenuating elastic body 16.

The reinforcer 48 is provided between one end in the longitudinal direction of the second attachment 14 reinforced by forming the outer tubular part 42 and the other end in the longitudinal direction of the second attachment 14 attached to the second attaching section 62 of the roof 58. This makes it possible to largely get the deformation rigidity of the second attachment 14 formed by overlapping the first and second plate-shaped members 28, 30.

The small groove 40 constituting the reinforcer 48 is continuously formed with the groove 32 constituting the outer tubular part 42. The second attachment 14 is reinforced continuously in the longitudinal direction by the reinforcer 48 and the outer tubular part 42, whereby it is possible to set high deformation rigidity for the second attachment 14. In particular, since the reinforcer 48 formed by the small grooves 40, 40 has a substantially tubular shape extending substantially coaxially with the outer tubular part 42 formed by the grooves 32, 32. Therefore, section modulus and second moment of area in the reinforcer 48 can be efficiently secured, and the rigidity in each direction of bending and torsion, etc. of the second attachment 14 can efficiently improve as well. Further, in the present practical embodiment, the central axis of the reinforcer 48 is set to be substantially the same as a straight line connecting the attachment points of the first attachment 12 and the second attachment 14 to the body skeleton 54, whereby the reinforcement effect further improves.

Moreover, the reinforcer 48 is formed to expand to the position where it does not reach the through hole 38. Thus, the degree of freedom in the shape of the second attachment 14 is secured largely in the through hole 38 attached to the roof 58 and the periphery of the through hole 38. In addition, in the attached state of the second attachment 14 to the body skeleton 54, the periphery of the through hole 38 is reinforced by attachment to the roof 58. Consequently, although the reinforcer 48 is formed at the position which does not reach the through hole 38, the deformation rigidity of the second attachment 14 can be largely provided.

The internal space 52 on the deeper side in the longitudinal direction of the outer tubular part 42 communicates with the external space through the passage hole 50 extending in the longitudinal direction along the outer peripheral face of the intermediate sleeve 24. Thus, in press-fitting the intermediate sleeve 24 into the outer tubular part 42, it is possible to prevent the internal space 52 of the outer tubular part 42 from being sealed. Therefore, it is possible to prevent the unnecessary initial load from acting on the high attenuating elastic body 16 by the air spring, and it is also possible to avoid difficulty in press-fitting the intermediate sleeve 24 into the outer tubular part 42.

It has been confirmed also by simulation that the vehicle skeleton support apparatus 10 having the structure according to the present practical embodiment exerts more excellent damping performance, as compared with a conventional vehicle skeleton support apparatus.

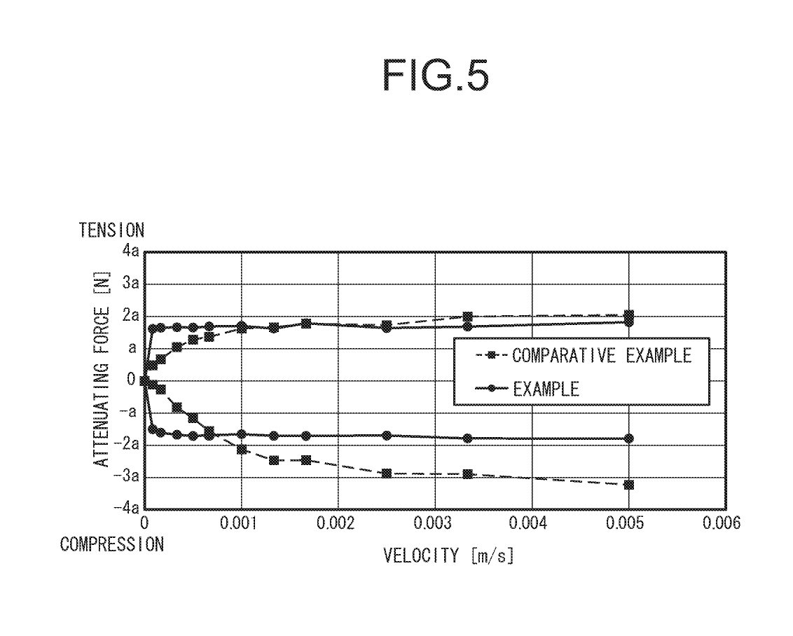

That is, FIG. 5 shows a simulation result of the attenuating force in relation to inputs in the axial direction, with respect to the vehicle skeleton support apparatus 10 as Example and the vehicle skeleton support apparatus of the conventional structure using the flow resistance of the fluid as Comparative Example. In the graph of FIG. 5, the horizontal axis represents the deformation velocity of the body skeleton 54, indicating the axial input on the vehicle skeleton support apparatuses. Meanwhile, the vertical axis shows the magnitude of the attenuating force exerted against the axial inputs. Specifically, the vertical center means the attenuating force is 0, and the upper side shows the magnitude of the attenuating force with respect to the tension input, while the lower side shows the magnitude of the attenuating force with respect to the compression input.

According to the graph of FIG. 5, in Example, a larger attenuating force than that of Comparative Example is exerted, and the responsiveness to deformation of the body skeleton 54 is excellent, in the extremely low velocity region where the deformation velocity of the body skeleton 54 is small. Therefore, in Example according to the present invention, excellent damping performance can be obtained from the initial period of deformation of the body skeleton 54.

Furthermore, in Example, as compared with Comparative Example, the change in the attenuating force for the difference in the deformation velocity of the body skeleton 54 is small, and the velocity dependence of the attenuating force is suppressed as compared with Comparative Example. Consequently, stable damping action can be exerted for various inputs. Moreover, in Comparative Example, there is a large difference in the characteristics of the attenuating force between the compression side and the tension side, while in Example, substantially the same damping performance can be obtained on the compression side and the tension side.

As described above, it has been also confirmed from the simulation result that the vehicle skeleton support apparatus 10 having the structure according to the present practical embodiment has superior performance to the vehicle skeleton support apparatus of the conventional structure.

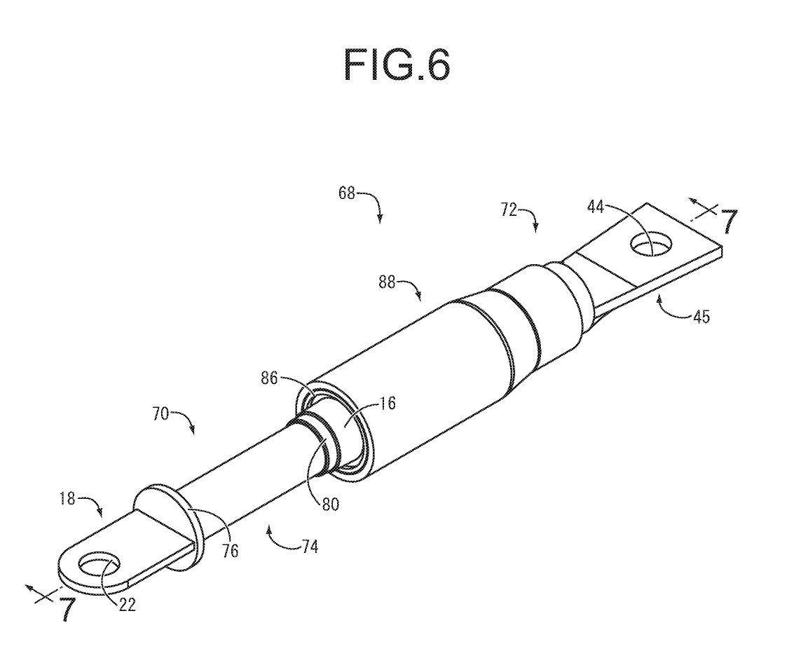

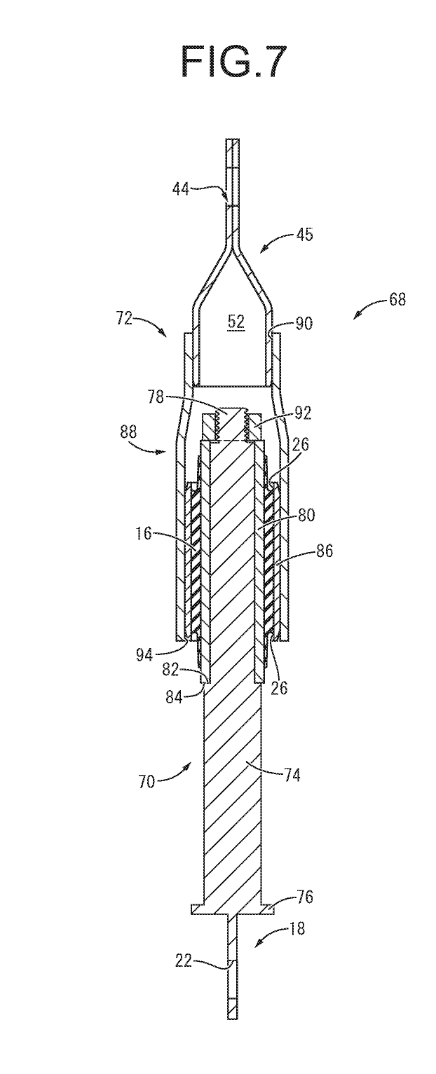

Next, with reference to FIGS. 6 to 7, a vehicle skeleton support apparatus 68 according to the second practical embodiment of the present invention will be described in detail. Members and parts having the same structures as those in the above practical embodiment are denoted by the same reference numerals as those in the above practical embodiment in the drawings, whereby a detailed description thereof will be omitted.

The vehicle skeleton support apparatus 68 has a structure wherein a first attachment 70 and a second attachment 72 are elastically connected to each other by the high attenuating elastic body 16. More specifically, the first attachment 70 is a high rigidity member made of iron, aluminum alloy, or the like. As shown in FIG. 7, the first attachment 70 has a substantially rod-like shape extending in the axial direction (the up-down direction in FIG. 7). A substantially cylindrical inner shaft-shaped part 74 is provided on one side of the first attachment 70 (the upper side in FIG. 7). Meanwhile, there is provided on the other side of the first attachment 70 (the lower side in FIG. 7), the attached part 18 having a substantially rectangular flat plate shape in a plan view.

The attached part 18 is provided with the first bolt hole 22 having a substantially circular cross section and penetrating it in the thickness direction (the left-right direction in FIG. 7). In the same way as the first practical embodiment described above, the attached part 18 is configured to be attached to the first attaching section 60.

On the other hand, as shown in FIGS. 6 to 7, the inner shaft-shaped part 74 has a substantially cylindrical shape as a whole. A flanged part 76 is provided at the base end portion (the lower end portion in FIG. 7) connected to the attached part 18, so as to have a flat plate shape projecting toward the axis-perpendicular direction across the entire circumference. Meanwhile, there is formed at the distal end of the inner shaft-shaped part 74, a screw part 78 protruding and having a thread formed over the entire outer peripheral face. The first attachment 70 of the present practical embodiment is formed for example by cutting an end portion of a pipe obtained by molding such as extrusion processing.

The inner shaft-shaped part 74 of the first attachment 70 has a smaller diameter on the distal end side than on the base end side, so that a step face 82 is formed at the middle part of the inner shaft-shaped part 74. A first intermediate sleeve 80 as the intermediate member is disposed radially outside the distal end side of the inner shaft-shaped part 74. The first intermediate sleeve 80 is formed of a metal such as iron or an aluminum alloy, in a substantially cylindrical shape having an inner diameter dimension smaller than the diameter of the base end side of the inner shaft-shaped part 74 and larger than the diameter of the distal end side of the inner shaft-shaped part 74. The first intermediate sleeve 80 has an axial dimension slightly larger than the axial dimension between the step face 82 of the inner shaft-shaped part 74 and the screw part 78. The step face 82 constitutes an engager that engages with a lower end face 84 of the first intermediate sleeve 80.

The first intermediate sleeve 80 as the intermediate member is inserted in a second intermediate sleeve 86 as another intermediate member. The high attenuating elastic body 16 is disposed between the first intermediate sleeve 80 and the second intermediate sleeve 86 in the axis-perpendicular direction. Here, the second intermediate sleeve 86 has a substantially cylindrical shape having a diameter smaller than that of an outer tubular part 88 described later and larger than that of the first intermediate sleeve 80, as well as a small axial dimension. The high attenuating elastic body 16 is a substantially cylindrical rubber, resin elastomer or the like and has a radially inner face fixed to the outer peripheral face of the first intermediate sleeve 80 and an outer peripheral face fixed to the radially inner face of the second intermediate sleeve 86. More specifically, as shown in FIG. 7, the second intermediate sleeve 86 is press-fitted into the outer tubular part 88 of the second attachment 72 as will be described later. The tubular first intermediate sleeve 80 and the tubular second intermediate sleeve 86 as the intermediate members each having a diameter smaller than that of the outer tubular part 88 are housed and disposed in the outer tubular part 88. As a result, the outer peripheral face of the high attenuating elastic body 16 is connected with the radially inner face of the second intermediate sleeve 86, in other words, with the radially inner face of the outer tubular part 88 via the second intermediate sleeve 86. The inner shaft-shaped part 74 and the outer tubular part 88 are elastically connected to each other in the axis-perpendicular direction by the high attenuating elastic body 16 via the first intermediate sleeve 80 and the second intermediate sleeve 86. The high attenuating elastic body 16 is provided with the groove-like void parts 26 which opens in the axial end faces and extends annularly in the circumferential direction, whereby the free face surely has a large area at the axial ends of the high attenuating elastic body 16.

The high attenuating elastic body 16 of the present practical embodiment is made of rubber and bonded by vulcanization to the first intermediate sleeve 80 and the second intermediate sleeve 86. Consequently, the high attenuating elastic body 16 takes the form of an integrally vulcanization molded component incorporating the first intermediate sleeve 80 and the second intermediate sleeve 86.

The second attachment 72 includes the outer tubular part 88 having openings on both sides in the axial direction (the up-down direction in FIG. 7), and the attached part 45 which is assembled to one of the openings 90 of the outer tubular part 88 and configured to be attached to the second attaching section 62.

Both of the outer tubular part 88 and the attached part 45 that constitute the second attachment 72 of the present practical embodiment are constituted by high rigidity members of iron, aluminum alloy or the like. The outer tubular part 88 has a structure wherein one end side of a substantially cylindrical pipe (the upper end in

FIG. 7) is slightly reduced in diameter in radial directions. Meanwhile, the attached part 45 has a structure wherein one end side of a substantially cylindrical pipe having a smaller diameter than that of one end side of the outer tubular part 88 (the upper end in FIG. 7) is crushed flat in a diametrical direction. The other end (the lower end in FIG. 7) of the attached part 45 is connected and secured to one of the openings 90 of the outer tubular part 88, by any well-known method, e.g., press-fitting, drawing, clinching, welding and the like, thereby constituting the second attachment 72 of the present practical embodiment.

The second bolt hole 44 having a substantially circular cross section penetrating in the thickness direction (the left-right direction in FIG. 7) is provided on one end side (the upper end portion in FIG. 7) of the attached part 45. In the same way as the case of the first practical embodiment described above, the attached part 45 is attached to the second attaching section 62.

In manufacturing the vehicle skeleton support apparatus 68 having this structure, in a state where the second intermediate sleeve 86 is externally disposed about the first intermediate sleeve 80 and the sleeves are disposed in the mold, the high attenuating elastic body 16 is filled in a gap between the first intermediate sleeve 80 and the second intermediate sleeve 86 in the axis-perpendicular direction so as to bond them by vulcanization. Next, the obtained integrally vulcanization molded component wherein the first intermediate sleeve 80 and the second intermediate sleeve 86 are bonded by vulcanization by the high attenuating elastic body 16 is press-fitted from the side of the other of the openings 94 of the outer tubular part 88. By so doing, the second intermediate sleeve 86 is press-fitted and fixed to the radially inner face of the outer tubular part 88. The integrally vulcanization molded component is securely disposed inside the outer tubular part 88. After that, a distal end of the inner shaft-shaped part 74 with a small diameter constituting the first attachment 70 is inserted into the first intermediate sleeve 80. In this state, a nut 92 is threaded onto the screw part 78 exposed from the side of one of the openings 90 of the outer tubular part 88, and the first intermediate sleeve 80 is clamped between the nut 92 and the step face 82. As a result, the inner shaft-shaped part 74 of the first attachment 70 is fixed to the first intermediate sleeve 80. That is, in the present practical embodiment, the fastener includes the screw part 78, the step face 82, and the nut 92. Finally, as shown in FIGS. 6 and 7, the attached part 45 is connected and fixed from the side of one of the openings 90 of the outer tubular part 88 constituting the second attachment 72, whereby the vehicle skeleton support apparatus 68 of the present practical embodiment is completed.

Like the case of the first practical embodiment described above, the vehicle skeleton support apparatus 68 structured as described above is attached to the single rigid member constituting the body skeleton 54 of the vehicle and used (see FIG. 4). As a result, it is possible to provide damping to the body skeleton 54 of the vehicle similarly to the case of the first practical embodiment described above, whereby the deformation of the body skeleton 54 can be reduced, so that the ride comfort and the running performance of the vehicle can improve. Moreover, by the simple structure wherein the inner shaft-shaped part 74 of the first attachment 70 and the outer tubular part 88 of the second attachment 72 are elastically connected by the high attenuating elastic body 16 in the axis-perpendicular direction, effective attenuation can be exerted in any case in relation to inputs in many directions. Therefore, it is possible to suppress the increase in the weight of the vehicle and the size of the necessary installation space, so as to secure a great degree of freedom of the mounting position in the body skeleton 54 of the vehicle. In addition, by adopting the intermediate member, it is unnecessary to use a structure of directly elastically connecting the inner shaft-shaped part 74 and the outer tubular part 88 with the high attenuating elastic body 16. Therefore, manufacturing efficiency can improve and the desired vibration damping performance can be reliably and stably exhibited.

Furthermore, the second attachment 72 includes the outer tubular part 88 having the openings 90, 94 on the both axial sides, and the attached part 45 to be assembled to one of the openings 90 of the outer tubular part 88. Moreover, the tubular first intermediate sleeve 80 and the tubular second intermediate sleeve 86 as the intermediate members having a diameter smaller than the diameter of the outer tubular part 88 are housed and disposed inside the outer tubular part 88. The sleeves are elastically connected to each other by the high attenuating elastic body 16 interposed between them. This makes it possible to more easily and securely assembling the integrally vulcanization molded component obtained by bonding the first intermediate sleeve 80 and the second intermediate sleeve 86 by vulcanization via the high attenuating elastic body 16, to the outer tubular part 88 and the inner shaft-shaped part 74, before assembling the outer tubular part 88 and the attached part 45. That is, it is possible to readily and efficiently insert the inner shaft-shaped part 74 into the first intermediate sleeve 80 and fasten them by the fasteners 78, 82, 92, and secure the second intermediate sleeve 86 press-fit into the outer tubular part 88, because the openings 90, 94 on the both axial sides of the outer tubular part 88 are released. Therefore, it is possible to easily manufacture the elastic coupling structure by the high attenuating elastic body 16 between the inner shaft-shaped part 74 and the outer tubular part 88, and it is possible to more advantageously and stably manufacture the vehicle skeleton support apparatus 68.

In the present practical embodiment, the first intermediate sleeve 80 is clamped between the nut 92 threaded onto the screw part 78 and the step face 82 provided at the middle part of the inner shaft-shaped part 74. This makes it possible to dispose the inner shaft-shaped part 74 across the entire length of the first intermediate sleeve 80. Therefore, when the vehicle skeleton support apparatus 68 is elongated, stable fixing of the first intermediate sleeve 80 and the inner shaft-shaped part 74 can be advantageously realized.

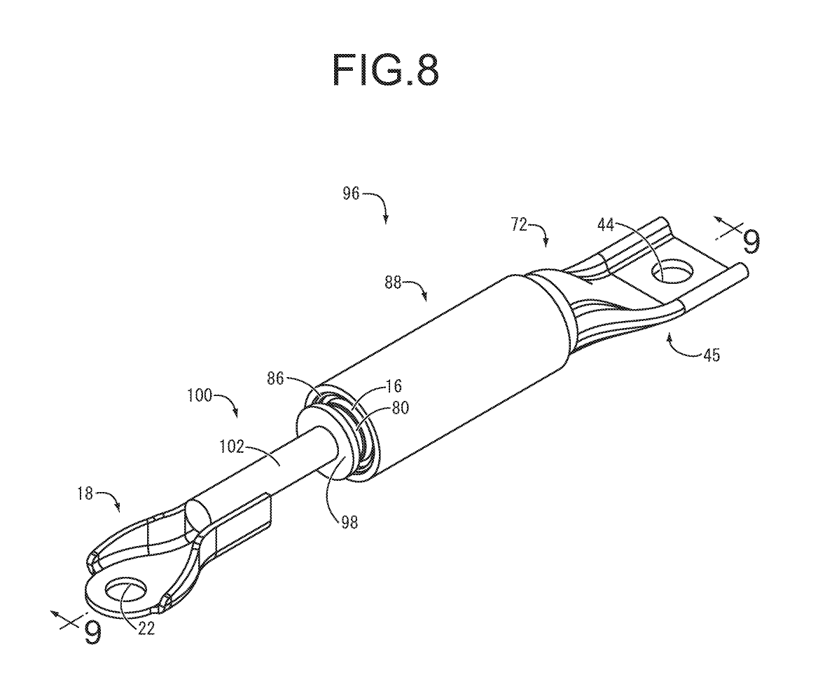

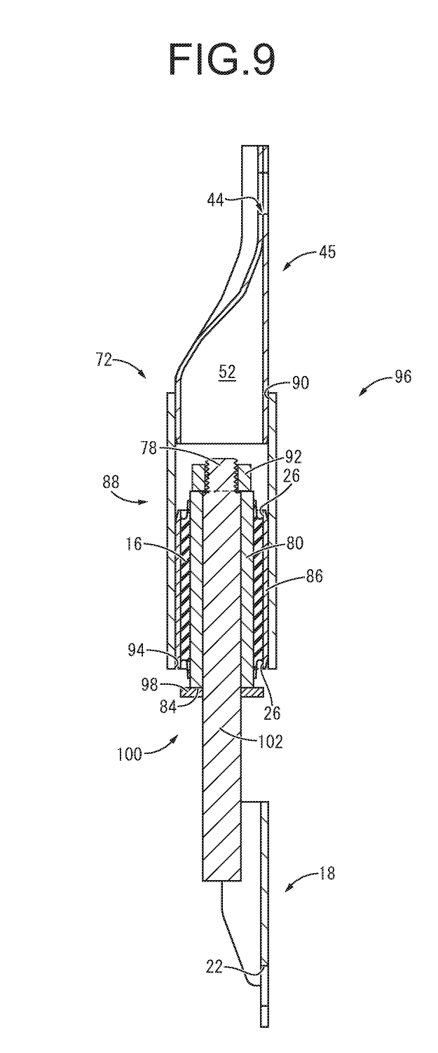

Subsequently, a vehicle skeleton support apparatus 96 serving as the third practical embodiment of the present invention will be described in detail with reference to FIGS. 8 to 9. However, members and parts having the same structures as those of the aforesaid practical embodiment are given the same reference numerals as those of the above practical embodiment in the drawings, and a detailed description thereof will be omitted. In this practical embodiment, a substantially annular ring 98 is fitted in the middle part of the inner shaft-shaped part 102, and the ring 98 constitutes the engager that engages with the lower end face 84 of the first intermediate sleeve 80, in which this practical embodiment is different from the above-mentioned second practical embodiment. As a result, the first intermediate sleeve 80, which is the intermediate member, can be clamped and fastened securely between the nut 92 and the ring 98 serving as the engager. Further, in the present practical embodiment, both of the attached parts 18, 45 extend in the axial direction and are substantially cullis-shaped to open upward (to the left side in FIG. 9). This makes it possible to improve the strength of the attached parts 18, 45, as compared with the first and second practical embodiments in which the attached parts 18, 45 are both in substantially flat plate shapes. The attached part 18 and an inner shaft-shaped part 102 constituting a first attachment 100 are formed separately, and the attached part 18 is attached to the end portion of the inner shaft-shaped part 102 by any method such as press fitting, clinching, and welding.

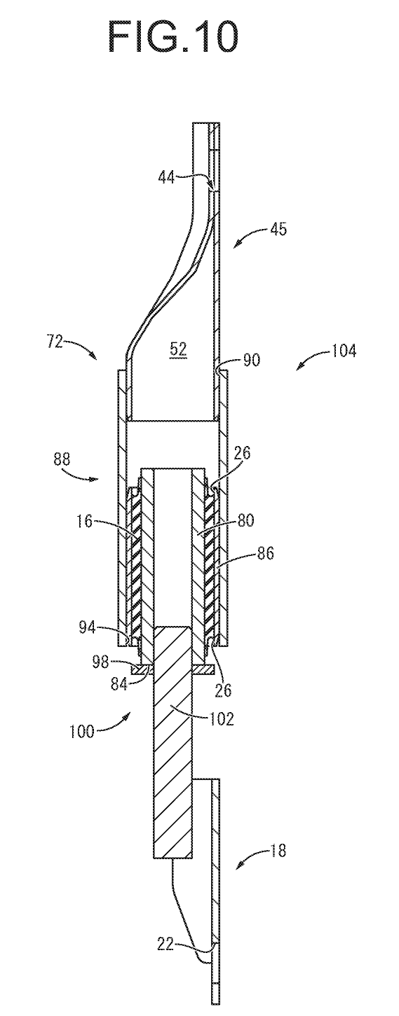

In the second to third practical embodiments, the fastener for fixing the inner shaft-shaped part 74, 102 and the first intermediate sleeve 80 includes the screw part 78, the engagers 82, 98 and the nut 92. However, it is possible, like a vehicle skeleton support apparatus 104 of another embodiment of the third practical embodiment of this invention shown in FIG. 10, that the mechanism for fixing the inner shaft-shaped part 102 and the first intermediate sleeve 80 is press-fitting of the inner shaft-shaped part 102 into the first intermediate sleeve 80. In this case, there is no need to dispose the inner shaft-shaped part 102 over the entire length of the first intermediate sleeve 80. Therefore, the inner shaft-shaped part 102 can be reduced in axial length to reduce the weight and cost while keeping the strength, for example when the total length of the vehicle skeleton support apparatus is not long.

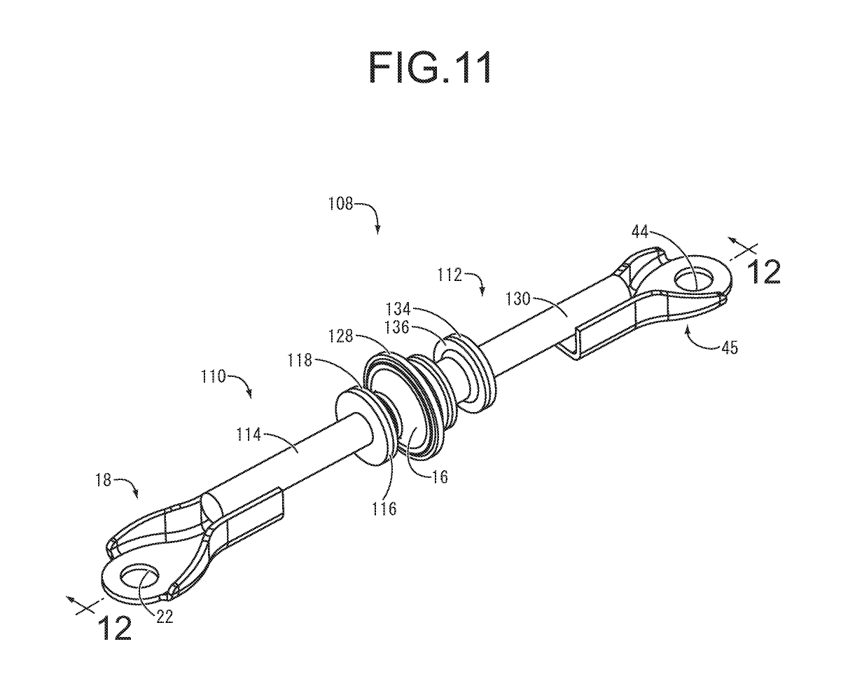

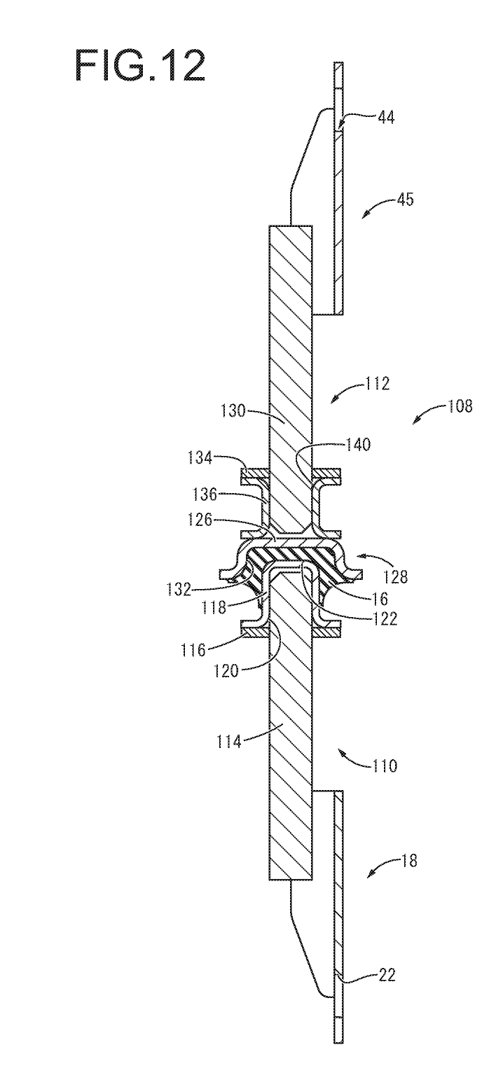

In reference to FIGS. 11 to 12, a vehicle skeleton support apparatus 108 serving as the fourth practical embodiment of this invention will be described in detail. However, for members and parts having the same structures as those of the above practical embodiment, the same reference numerals as those of the above practical embodiment are provided in the drawings, and a detailed description thereof will be omitted.

The vehicle skeleton support apparatus 108 also has a structure wherein a first attachment 110 and a second attachment 112 are elastically connected to each other by the high attenuating elastic body 16. More specifically, the first attachment 110 is a high rigidity member made of iron, aluminum alloy, or the like. As shown in FIG. 12, the first attachment 110 has an inner shaft-shaped part 114 which extends in the axial direction (the up-down direction in FIG. 12) substantially in a rod shape, and the attached part 18 assembled to one end portion (the lower end portion in FIG. 12) of the inner shaft-shaped part 114 and configured to be attached to the first attaching section 60.

The attached part 18 has a substantially cullis-like shape extending in the axial direction and opening upward (to the left side in FIG. 12). The attached part 18 has the first bolt hole 22 passing through it in the thickness direction (the left-right direction in FIG. 12) with a nearly circular cross section, on the distal end side (the lower end in FIG. 12). The attached part 18 is attached to the first attaching section 60, similarly to the first to third practical embodiments described above.

As shown in FIGS. 11 to 12, the inner shaft-shaped part 114 has a substantially cylindrical shape as a whole. A generally annular ring 116 is fitted on the other end side (the upper end portion in FIG. 12) of the inner shaft-shaped part 114. The ring 116 touches an intermediate member 118 when the inner shaft-shaped part 114 is press-fitted and secured, through an axial opening 120 of the substantially bottomed cup-shaped intermediate member 118, toward a bottom wall 122. As a result, the distal end portion (the upper end portion in FIG. 12) of the inner shaft-shaped part 114 does not reach the bottom wall 122 of the intermediate member 118. The intermediate member 118 is formed by pressing process or the like using a metal such as iron or an aluminum alloy. Further, the ring 116 is fixed to the outer peripheral face of the inner shaft-shaped part 114 by welding or the like.

The second attachment 112 is a high rigidity member made of iron, aluminum alloy, or the like. As shown in FIG. 12, the second attachment 112 includes an outer tubular part 128 having a bottomed cup shape and having a base wall 126 positioned at one end in the axial direction, which is the up-down direction in FIG. 12 (on the lower side in FIG. 12). The second attachment 112 further includes a roughly rod-like outer shaft-shaped part 130 which is positioned in the middle in the axial direction while extending in the axial direction. The second attachment 112 further includes the attached part 45 which is located at the other axial end portion (the upper side in FIG. 12) and assembled to the upper end portion of the outer shaft-shaped part 130 and configured to be attached to the second attaching section 62.

The attached part 45 has a substantially cullis-like shape extending in the axial direction and opening upward (to the left side in FIG. 12). The attached part 45 has the second bolt hole 44 passing through it in the thickness direction (the left-right direction in FIG. 12) with a nearly circular cross section, on the distal end side (the upper end in FIG. 12). The attached part 45 is attached to the second attaching section 62, similarly to the first to third practical embodiments described above.

The intermediate member 118 having a diameter smaller than that of the outer tubular part 128 is housed and disposed inside the outer tubular part 128. Then, the high attenuating elastic body 16 such as a rubber elastic body is filled in a gap between the base wall 126 of the outer tubular part 128 and the bottom wall 122 of the intermediate member 118 that face each other, and between a radially inner face 132 of the outer tubular part 128 and a face of the intermediate member 118 that face each other. As a result, the high attenuating elastic body 16 is bonded by vulcanization to the outer tubular part 128 and the intermediate member 118, and the outer tubular part 128 and the intermediate member 118 are elastically connected in the gap. A nearly cylindrical press-fit tubular part 136 is disposed coaxially with the outer tubular part 128, on the side of the outer face of the base wall 126 of the outer tubular part 128 (the upper side in FIG. 12) and integrally fixed by welding, etc.

As shown in FIGS. 11 to 12, the outer shaft-shaped part 130 has a generally cylindrical shape as a whole. A generally annular ring 134 is fitted and fixed by welding or the like on the other end side (the lower end portion in FIG. 12) of the outer shaft-shaped part 130. The other end of the outer shaft-shaped part 130 is press-fitted into the press-fit tubular part 136 and is securely assembled. A press-fitting end of the outer shaft-shaped part 130 to the press-fit tubular part 136 is regulated by abutment of the ring 134 on the side of an upper opening 140 of the press-fit tubular part 136. As a result, the distal end of the outer shaft-shaped part 130 does not touch the base wall 126 of the outer tubular part 128.

In manufacturing the vehicle skeleton support apparatus 108 having this structure, an integrally molded component in which the outer tubular part 128 and the intermediate member 118 are elastically connected by the high attenuating elastic body 16 is obtained in advance. After that, it is possible to easily manufacture the vehicle skeleton support apparatus 108, only by securing the inner shaft-shaped part 114 press-fit into the intermediate member 118, while securing the outer shaft-shaped part 130 press-fit into the press-fit tubular part 136 fixed to the outer tubular part 128. Therefore, similarly to the above-described practical embodiment, it is possible to easily and stably manufacture the elastic coupling structure between the inner shaft-shaped part 114 and the outer tubular part 128 by the high attenuating elastic body 16.

As the first to third practical embodiments described above, the vehicle skeleton support apparatus 108 structured as described above is attached to the single rigid member constituting the body skeleton 54 of the vehicle to be used (see FIG. 4). As a result, it is possible to provide damping to the body skeleton 54 of the vehicle, like the first to third practical embodiments described above, so that the deformation of the body skeleton 54 can be reduced and the ride comfort and the running performance of the vehicle can improve. Moreover, by the simple structure wherein the inner shaft-shaped part 114 of the first attachment 110 and the outer tubular part 128 of the second attachment 112 are elastically connected by the high attenuating elastic body 16 in the axis-perpendicular direction, effective attenuation can be exerted in any case in relation to inputs in many directions. Therefore, it is possible to suppress the increase in the weight of the vehicle and the size of the necessary installation space, so as to secure a great degree of freedom of the mounting position in the body skeleton 54 of the vehicle. In addition, by adopting the intermediate member, it is unnecessary to use a structure of directly elastically connecting the inner shaft-shaped part 114 and the outer tubular part 128 with the high attenuating elastic body 16. Therefore, manufacturing efficiency can improve and the desired vibration damping performance can be reliably and stably exhibited.

Further, the intermediate member 118 having a diameter smaller than that of the outer tubular part 128 and having a bottomed cup shape is housed and disposed in the outer tubular part 128 having a bottomed cup shape. The high attenuating elastic body 16 is filled between the peripheral walls and between the bottom wall 122 and the base wall 126 that face each other so as to elastically connect them. Therefore, not only the damping action is exerted against any relative displacement in the torsional direction, which is the axial rotation direction between the first attachment 110 and the second attachment 112, and the prizing direction in the axis-perpendicular direction, but also compression and tensile springs are exerted against relative axial displacement between the first attachment 110 and the second attachment 112. Consequently, further vibration damping characteristics can be added.

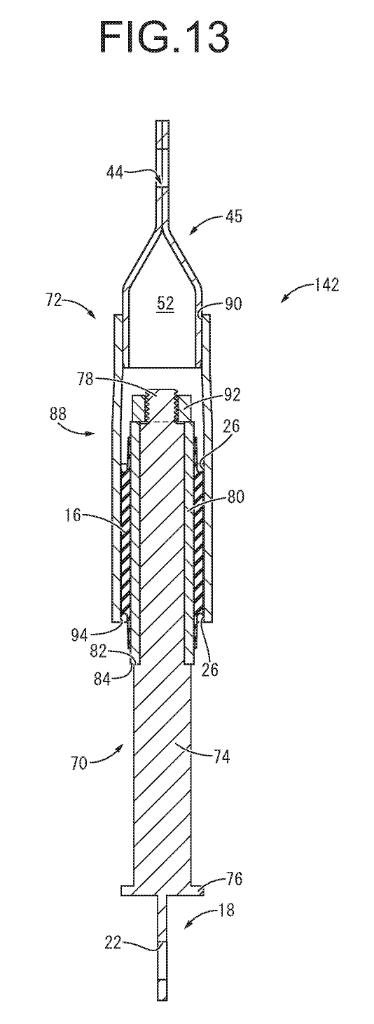

Although the practical embodiments of the present invention have been described in detail above, this invention is not limited by the specific description of the practical embodiments. For example, as a structure for fixing the inner shaft-shaped parts 74, 102 to the first intermediate sleeve 80, any well-known fastening structure such as rivets instead of the screws employed in the second to third practical embodiments or press fitting, etc. can be adopted. In the second to third practical embodiments, the outer peripheral face of the high attenuating elastic body 16 is indirectly connected via the second intermediate sleeve 86. However, like a vehicle skeleton support apparatus 142 of another embodiment of the second practical embodiment of this invention shown in FIG. 13, the outer peripheral face of the high attenuating elastic body 16 may be directly fixed and connected to the outer tubular part 88.

The first attachment 12 is not limited to the tubular shape as shown in the above practical embodiment, and it may have a solid rod shape or the like. As well, the structure of the second attachment is not interpreted in a limited way by the specific description of the above practical embodiments. For example, the whole second attachment may be integrally formed by molding. In addition, the second attachment 14 is not necessarily limited to the divided structure as in the present practical embodiment. Alternatively, the second attachment can also be formed into an integral structure by crushing a pipe molded by extrusion processing. Furthermore, in the first practical embodiment, the first plate-shaped member 28 and the second plate-shaped member 30 constituting the second attachment 14 are each formed of a press metal fitting made of metal such as iron or aluminum alloy.

However, the second attachment 14 may be, for example, a molded article such as a metal casting item, and a die casting item or an item made of fiber-reinforced resin.

The attachment parts in the body skeleton 54 of the vehicle to which the vehicle skeleton support apparatuses 10, 68, 96, 104, 108, 142 are attached are not limited to the connecting parts between the center pillar 56 and the roof 58 arranged in the middle in the front-back direction of the vehicle. Specifically, for example, the apparatus can be preferably attached also to a connecting portion of a pillar including a front pillar and a rear pillar disposed at an end in the vehicle front-back direction to a roof or a floor, a corner portion of a fender, a corner portion of a roof or a floor, and a vicinity of a front or rear bumper. Preferably, the vehicle skeleton support apparatuses 10, 68, 96, 104, 108, 142 are arranged obliquely with respect to corners such as a branch portion and a bent portion in the single rigid member constituting the vehicle body skeleton 54 and attached so as to connect the two sides of the rigid member constituting the corner portion. Although it is desirable that the entire rigid member is a single member like a monocoque structure, a plurality of members may be integrally connected by welding or the like to form it. The rigid member will do as long as the entirety can be regarded as an integral rigid body. In addition, the vehicle skeleton support apparatus 10 can also be used as a part of a reinforcing bracket (such as a brace) for improving the body rigidity.

Further, it is possible to provide anisotropy in the circumferential direction, to the spring characteristics and damping capabilities of the high attenuating elastic body 16, by forming a hole penetrating the high attenuating elastic body 16 in the axial direction, changing the axial thickness dimension of the high attenuating elastic body 16 in the circumferential direction, or the like.

What is claimed is:

1. A vehicle skeleton support apparatus configured to be attached and disposed in a vehicle body skeleton comprising:
a first attachment and a second attachment configured to be attached respectively at a first attaching section and a second attaching section set at separate positions in a single rigid member constituting the body skeleton;
an inner shaft-shaped part provided at the first attachment;
an outer tubular part provided at the second attachment, the outer tubular part being externally disposed about the inner shaft-shaped part;
a high attenuating elastic body elastically connecting the inner shaft-shaped part and the outer tubular part with each other in an axis-perpendicular direction; and
an intermediate member interposed in a connection part of the high attenuating elastic body to at least one of the inner shaft-shaped part and the outer tubular part such that the high attenuating elastic body is connected with the at least one via the intermediate member, wherein
an attenuating action by deformation of the high attenuating elastic body is exhibited in relation to relative displacement between the first attachment and the second attachment in any of an axial direction, the axis-perpendicular direction, a torsional direction, and a prizing direction.

2. The vehicle skeleton support apparatus according to claim 1, wherein at least one of the first attachment and the second attachment is constituted by a press metal fitting.

3. The vehicle skeleton support apparatus according to claim 1, wherein at least one of the first attachment and the second attachment is constituted by a molded article.

4. The vehicle skeleton support apparatus according to claim 1, wherein at least one of the first attachment and the second attachment is constituted by a fiber-reinforced resin or an aluminum alloy.

5. The vehicle skeleton support apparatus according to claim 1, wherein the high attenuating elastic body is constituted by an isobutylene-isoprene based rubber or a styrene-butadiene based rubber.

6. The vehicle skeleton support apparatus according to claim 1, wherein
the second attachment has a structure wherein first and second plate-shaped members which are each formed by an elongated press plate metal fitting are superposed on each other,
two grooves are formed in the first and second plate-shaped members so as to extend linearly in a longitudinal direction of the first and second plate-shaped members with a semi-circular cross section, and one side end of the grooves is an opened end at an end edge in the longitudinal direction, while an other side end of the grooves is a terminal in a middle part in the longitudinal direction of the first and second plate-shaped members,
the grooves in the first and second plate-shaped members are superposed on each other so as to constitute the outer tubular part into which the inner shaft-shaped part is inserted,
superposition areas in both side parts in a width direction of the grooves and in an edge part on a side of the terminal in the longitudinal direction in the first and second plate-shaped members are fixed to each other, and
the intermediate member comprises an intermediate sleeve fixed on an outer peripheral face of the high attenuating elastic body, and the intermediate sleeve is secured press-fit into the outer tubular part constituted by the grooves of the first and second plate-shaped members so that the outer peripheral face of the high attenuating elastic body is fixed to the outer tubular part.

7. The vehicle skeleton support apparatus according to claim 6, further comprising:
an attached part configured to be attached to the second attaching section of the rigid member, the attached part being provided in the first and second plate-shaped members, on a side of the other side end located opposite to the opened end of the grooves in the longitudinal direction; and
a reinforcer extending from the terminal of the grooves toward the attached part, the reinforcer being constituted by small grooves extending in the longitudinal direction with a cross sectional shape smaller than a cross sectional shape of the grooves being superposed on each other, in the first and second plate-shaped members.

8. The vehicle skeleton support apparatus according to claim 7, wherein
the attached part includes a through hole penetrating the first and second plate-shaped members in a superposition direction of the first and second plate-shaped members,
the small grooves constituting the reinforcer open in the terminal of the grooves constituting the outer tubular part, and the small grooves are provided with a length such that the small grooves do not reach the through hole in the longitudinal direction of the first and second plate-shaped members.

9. The vehicle skeleton support apparatus according to claim 6, wherein
a passage hole is provided in the outer tubular part which is constituted by the first and second plate-shaped members while extending in the longitudinal direction along an outer peripheral face of the intermediate sleeve, in superposition parts of both circumferential ends of the grooves of the first and second plate-shaped members, and
an internal space on a deeper side in the longitudinal direction in the outer tubular part into which the inner shaft-shaped part and the high attenuating elastic body are inserted communicates with an external space via the passage hole.

10. The vehicle skeleton support apparatus according to claim 1, wherein
the second attachment includes the outer tubular part having two openings on opposite axial sides, and an attached part assembled to one of the openings of the outer tubular part and configured to be attached to the second attaching section,
the intermediate member comprises a tubular first intermediate sleeve with a diameter smaller than a diameter of the outer tubular part, and the first intermediate sleeve is housed and disposed in the outer tubular part, and an outer peripheral face of the high attenuating elastic body is connected with a radially inner face of the outer tubular part, while a radially inner face of the high attenuating elastic body is fixed to an outer peripheral face of the first intermediate sleeve, and
the inner shaft-shaped part of the first attachment is inserted in the first intermediate sleeve from a side of an other of the openings of the outer tubular part, and the inner shaft-shaped part is fixed to the first intermediate sleeve by a fastener.

11. The vehicle skeleton support apparatus according to claim 10, wherein a screw part protrudes in a distal end of the inner shaft-shaped part of the first attachment, and an engager is provided at a middle part of the inner shaft-shaped part so as to engage with an end face of the first intermediate sleeve, and the first intermediate sleeve is clamped between a nut threaded onto the screw part and the engager so that the inner shaft-shaped part of the first attachment is fixed to the first intermediate sleeve, and the fastener includes the screw part, the engager, and the nut.

12. The vehicle skeleton support apparatus according to claim 1, wherein
the second attachment includes the outer tubular part having two openings on opposite axial sides, and an attached part assembled to one of the openings of the outer tubular part and configured to be attached to the second attaching section,
the intermediate member comprises a tubular first intermediate sleeve with a diameter smaller than a diameter of the outer tubular part, and the first intermediate sleeve is housed and disposed in the outer tubular part, and an outer peripheral face of the high attenuating elastic body is connected with a radially inner face of the outer tubular part, while a radially inner face of the high attenuating elastic body is fixed to an outer peripheral face of the first intermediate sleeve, and
the inner shaft-shaped part of the first attachment is secured press-fit into the first intermediate sleeve from a side of an other of the openings of the outer tubular part.

13. The vehicle skeleton support apparatus according to claim 10, wherein the intermediate member further comprises a tubular second intermediate sleeve with a diameter smaller than the diameter of the outer tubular part and larger than the diameter of the first intermediate sleeve, and the second intermediate sleeve is housed and disposed in the outer tubular part, and the outer peripheral face of the high attenuating elastic body is fixed to a radially inner face of the second intermediate sleeve, while the radially inner face of the high attenuating elastic body is fixed to the outer peripheral face of the first intermediate sleeve, and the second intermediate sleeve is secured press-fit into the outer tubular part so that the outer peripheral face of the high attenuating elastic body is connected with the outer tubular part.

14. The vehicle skeleton support apparatus according to claim 1, wherein
the outer tubular part provided at the second attachment has a bottomed cup shape with a base wall provided at one axial end,
the intermediate member in a bottomed cup shape with a diameter smaller than a diameter of the outer tubular part is housed and disposed in the outer tubular part, and the high attenuating elastic body is filled in a gap between a face of the base wall of the outer tubular part and a face of a bottom wall of the intermediate member that face each other and a gap between a radially inner face of the outer tubular part and a face of the intermediate member that face each other so that the high attenuating elastic body elastically connects the outer tubular part and the intermediate member in the gaps, and
the inner shaft-shaped part of the first attachment is secured press-fit into the intermediate member from an axial opening of the intermediate member toward the bottom wall.
